(19) United States
(12) Patent Application Publication
(10) Pub. No.: US 2016/0366264 A1
(43) Pub. Date: Dec. 15, 2016

(54) TRANSFERRING INFORMATION DURING A CALL

(71) Applicant: International Business Machines Corporation, Armonk, NY (US)

(72) Inventors: Vijay Ekambaram, Tamilnadu (IN); Ashish K. Mathur, Bangalore (IN); Mahesh B. Selvam, Bangalore (IN)

(21) Appl. No.: 14/737,886

(22) Filed: Jun. 12, 2015

(51) Int. Cl. H04M 1/725; G06F 3/01; G06F 3/0346; G10L 15/26; G06F 3/16; G06F 17/24; G06F 17/22; G06F 3/0484; G06F 3/0488

(52) U.S. Cl. CPC H04M 1/72519; G06F 3/04842; G06F 3/017; G06F 3/0346; G06F 3/04883; G06F 3/167; G06F 17/24; G06F 17/2211; G10L 15/265

(57) ABSTRACT

Embodiments of the present invention provide systems and methods for sending information during a call. In one embodiment, an individual receives a request for information while using a device. The requested information is located on the device in use. Sending the requested information involves utilizing hovering gestures, recording audio, converting recorded audio to text, and correlating recorded audio with the text. Extracting the requested information may include deleting extraneous information and accounting for inconsistencies in pronunciation.

### BACKGROUND OF THE INVENTION

The present invention relates generally to the field of telecommunications technology and more specifically to retrieving requested data from one device during a conversation, and automatically sending the requested data to a receiving device.

During the course of verbal communication over a set of two devices among two parties, one user may request certain information stored on one of the devices from another user. Such information may include phone numbers, addresses, serial numbers, full names, etc. In order to convey the requested information, often the sending party may engage in a process of receiving the request; searching through the mobile device owned by the sending party to find the requested information; noting the information down on paper, a text editor in the mobile device, or some other medium; and reading the noted information to the requesting party during the conversation. During this process, the phone call may get disconnected when the text editor is opened, and recording errors (e.g., due to errors in pronunciation or different interpretation of information recited out loud) may take place.

### SUMMARY

According to one embodiment of this present invention. A method for sending information during a call, the method comprising: receiving, by one or more processors, a type of gesture during the call and a user selection; responsive to receiving the user selection, recording, by one or more processors, a portion of a conversation; and converting, by one or more processors, a recorded portion of the conversation to text and sending a requested piece of information.

Another embodiment of the present invention provides a computer program product for sending information during a call based on the method described above.

Another embodiment of the present invention provides a computer system for sending information during a call based on the method described above.

### BRIEF DESCRIPTION OF THE DRAWINGS

FIG. 1 is a functional block diagram illustrating a communication processing environment, in accordance with an embodiment of the present invention;

FIG. 2 is a flowchart illustrating the operational steps of receiving an information request, extracting the information, and relaying it to the requester, in accordance with an embodiment of the present invention;

FIG. 3A is an example of a mobile screen display upon initiation of gyroscopic sensors, in accordance with an embodiment of the present invention;

FIG. 3B is an example of a user interface displaying a hierarchy mode, in accordance with an embodiment of the present invention;

FIG. 3C is an example of the captured relevant text with respect to the information requested, in accordance with an embodiment of the present invention;

FIG. 4 is an example of correlating captured text from a hierarchy mode with the text from recording audio, in accordance with an embodiment of the present invention; and

FIG. 5 depicts a block diagram of internal and external components of a computing device, in accordance with an embodiment of the present invention.

### DETAILED DESCRIPTION

Individuals may request information from another individual during a telephone conversation. The requested information may be located on the device of the individual receiving the request and thus needs to be extracted and eventually sent to the individual requesting the information. Recorded conversations may not accurately convert to text due to variations in pronunciation; raise privacy concerns (as people do not want their private conversations to be recorded); and utilize substantial battery power of the device. Embodiments of the present invention allow for efficient extraction of requested information from one mobile device in use by one individual to another device concomitantly in use by another individual. Application of these methods allows for accurate conversion of audio to text; limits privacy concerns; and utilizes less energy.

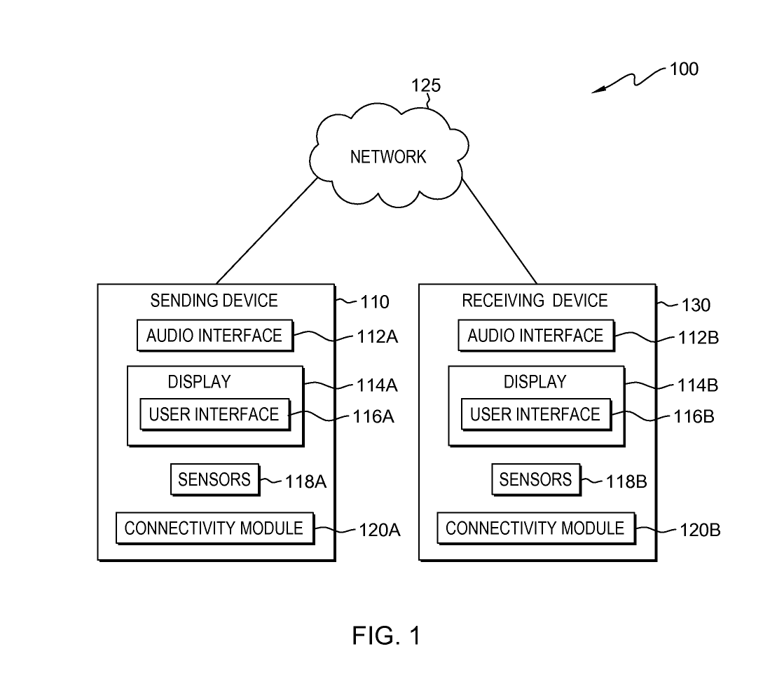

The present invention will now be described in detail with reference to the Figures. FIG. 1 is a functional block diagram illustrating a communication processing environment, generally designated 100, in accordance with one embodiment of the present invention. FIG.1 provides only an illustration of implementation and does not imply any limitations with regard to the environments in which different embodiments may be implemented. Modifications to data processing environment 100 may be made by those skilled in the art without departing from the scope of the invention as recited by the claims. In this exemplary embodiment, data processing environment 100 includes sending device 110 and receiving device 130, interconnected via network 125.

Network 125 may be a local area network (LAN), a wide area network (WAN) such as the Internet, the public switched telephone network (PSTN), a mobile data network (e.g., wireless Internet provided by a third or fourth generation of mobile phone mobile communication), a private branch exchange (PBX), any combination thereof, or any combination of connections and protocols that will support communications between sending device 110 and receiving device 130, in accordance with embodiments of the invention. Network 125 may include wired, wireless, or fiber optic connections.

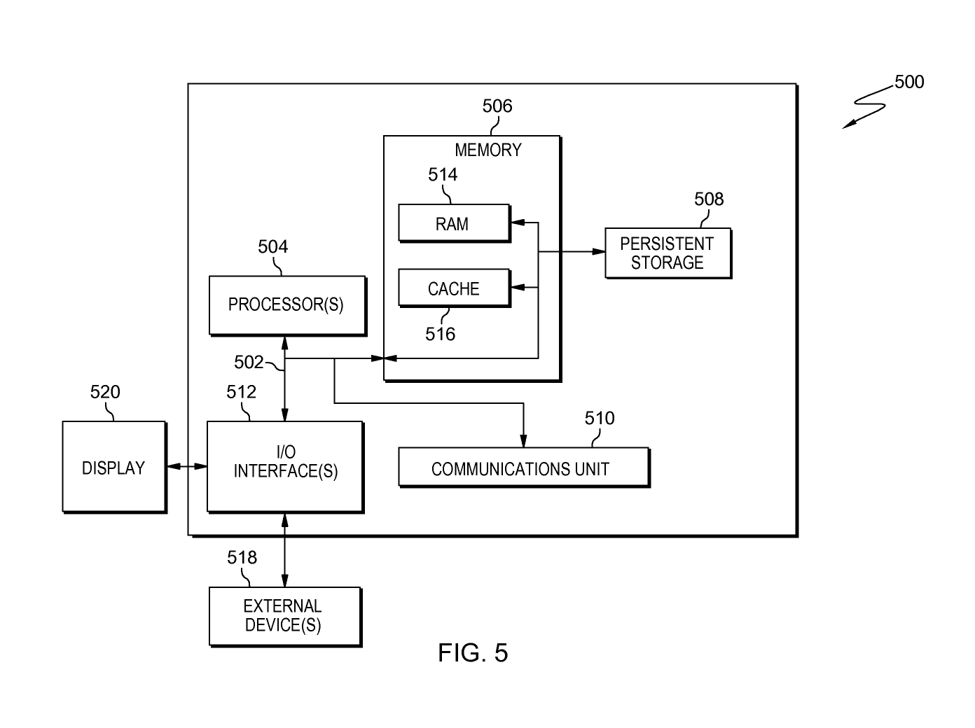

Sending device 110 and receiving device 130 are a smart phone. In other embodiments, sending device 110 and receiving device 130 may be a laptop computer, a tablet computer, a thin client, or personal digital assistant (PDA). In general, sending device 110 and receiving device 130 may be any mobile electronic device or mobile computing system capable of sending and receiving data, and communicating with a receiving device over network 125. Sending device 110 and receiving device 130 may include internal and external hardware components, as depicted and described in further detail with respect to FIG. 5. Sending device 110 contains audio interface 112A, display 114A, user interface 116A, sensor 118A, and connectivity module 120A. Receiving device 130 contains audio interface 112B, display 114B, user interface 116B, sensor 118B, and connectivity module 120B.

In this exemplary embodiment, audio interfaces 112A and 112B include a recording component in order to record audio, a speaker component in order to output audio to a listener, and a microphone component in order to input audio to a listener. Audio interface contains an audio codec device (not pictured) which can code or decode a digital data stream of audio.

In this exemplary embodiment, display 114A and 114B may be composed of, for example, a liquid crystal display screen, an organic light emitting diode display screen, or other types of display screens. Display 114A and 114B contain user interface (UI) 116A and 116B, respectively. Display 114A and 114B consist of a screen where the screen (which has touch screen capability) is composed of an insulator such as glass coated with a transparent electrical conductor—indium titanium oxide.

User interface 116A and 116B may be for example, a graphical user interface (GUI) or a web user interface (WUI) and can display text, documents, web browser windows, user options, application interfaces, and instructions for operation, and includes the information (such as graphics, text, and sound) a program presents to a user and the control sequences the user employs to control the program. User interface 116A and 116B is capable of receiving data, user commands, and data input modifications from a user.

In this exemplary embodiment, sensors 118A and 118B contain temperature sensors which measure ambient temperatures, light sensors which measure changes in light intensity, and gyroscopic sensors which measure changes in orientation based on the principles of angular momentum.

In this exemplary embodiment, connectivity module 120A and 120B contain a baseband processor which manages all the radio or any functions that require an antenna, such as WiFi and Bluetooth functions, for connecting to a wireless network, such as the Internet, and for connecting to other devices. Connectivity module 120A and 120B include a subscriber identification module (SIM) which protects, identifies, and authenticates the identity of the user of the phone.

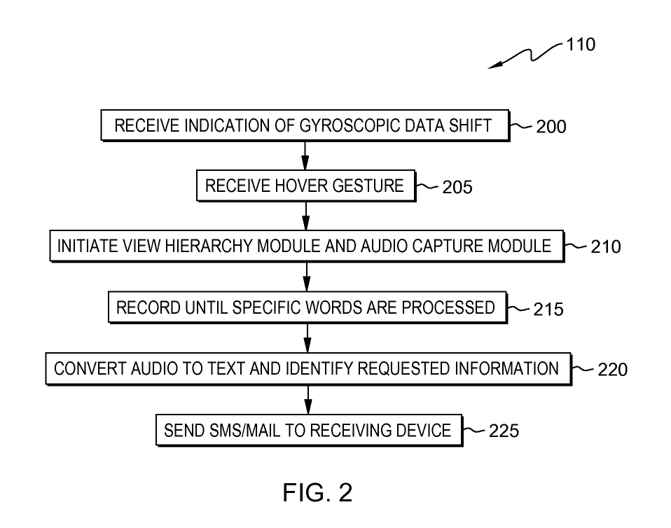

FIG. 2 is a flowchart illustrating the operational steps for communicating requested data during a call conversation, in accordance with an embodiment of the present invention. For illustrative purposes, the following discussion is made with respect to sending device 110; it being understood that the operational steps of FIG. 2 may be performed by receiving device 130, or by other computing devices not pictured in FIG. 1.

In step 200, sending device 110 receives an indication of a gyroscopic data shift. During the course of a conservation between individuals via a set of devices, a sending device in use by an individual receives a request for specific information contained within the sending device in use by the individual from a receiving device in use by another individual. The information located on the sending device may be a cell phone number, address, serial number, account number, etc. In this exemplary embodiment, sending device 110 receives an indication of a gyroscopic data shift when changing the position of sending device 110 (e.g., bringing sending device 110 from ear to the front of eyes). Gyroscopic sensors may detect a gyroscopic data shift by detecting a change in angular velocity, a change in angles of the devices, or an initiation of control mechanisms which correlate to the gyroscopic data shift.

In step 205, sending device 110 receives a hover gesture. In this exemplary embodiment, sending device 110 has capacitive touch sensors which can detect the position of the finger of a user, without touching the screen. The human body acts as an electrical conductor so in turn when an individual's finger hovers over, or touches the screen, an electric current is generated. The generated electric current interacts with the screen and induces a change in the electrostatic field of the screen, which in turn leads to measureable change in capacitance. For example, sending device 110 may receive a finger circling gesture from the individual who facilitated the change of position of the sending device 110. The figure circling gesture is carried out on any screen in the device such as an entry in the call history, which has the requested phone number information, is circled.

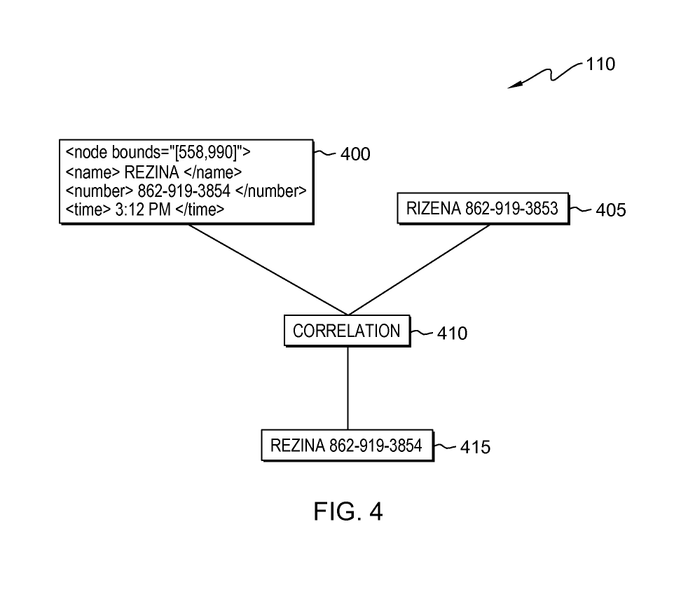

In step 210, sending device 110 initiates a hierarchy module and an audio capture module. In this exemplary embodiment, sending device 110 begins recording the conversation via the audio capture module, upon receiving a hover gesturing and initiating the hierarchy module followed by the gyroscopic data shift in position of sending device 110 (from front view of user to ears of user). The hierarchy module captures a hierarchy view as an extensible markup language (XML) of elements which are visible on the screen. XML defines a set of rules for encoding documents in a format which is both human-readable and machine-readable. XML inserts an annotation (i.e., metadata) in a document in a way that is syntactically distinguishable from the text. Metadata is a comment, explanation, presentational markup attached to text, image, or other data. The hierarchy view modules are depicted as a tree-diagram in order to describe its hierarchal nature in graphical form. Nodes are elements of the tree-diagram and lines connecting the nodes are called branches. As described above, the capacitive touch sensor actions capture a pixel area of interest on the screen of sending device 110. The pixel area contains the information requested by another individual where the pixel area is correlated to the hierarchy view in XML node form. Sending device 110 captures text from a hierarchy module in XML node form. Details regarding the hierarchal view are further described in FIG. 4.

In step 215, sending device 110 records audio of a conversation until a set of specific words or gestures are processed by sending device 110. In this exemplary embodiment, sending device 110 begins an audio capture module initiated upon triggering a hierarchy module and ceases the audio capture module upon processing a set of pre-determined spoken key words or gestures. Such processing technology is available on devices such as mobile phones, tablets, etc. The audio codec described above has an audio input which is stored in memory storage. The set of specific words which cease the audio capture module may be preconfigured. For example, sending device 110 is preconfigured by the individual such that the spoken key word is “done.” Sending device 110 conveys requested information to a receiving device in use by another individual and ceases the audio capture mode upon processing the word “done.” As limited portions of the communication of the sending device 110 in use by an individual and the receiving device in use by another individual are recorded, privacy concerns may be mitigated.

In step 220, sending device 110 converts the captured audio to text and identifies the requested information. Sending device 110 converts the captured audio to text using conversion methods known in the art. In this exemplary embodiment, sending device 110 stores the audio converted to text in the memory of sending device 110. A correlation analysis is conducted by the device in order to identify the requested information. The hierarchy view which is initiated upon receiving the hover gesture, captures certain elements visible on the screen as text in XML node form. The captured elements may include extraneous information (i.e., unwanted information) not relevant to the information requested. An algorithm which utilizes string analysis performs the correlation analysis on the audio and text in order to identify the requested information by disambiguating pronoun pronunciation, finding extraneous or unwanted information, and finding similarities between the audio and text. For example, the hierarchy view may contain a phone number and a time of call. The requested information is for the phone number only (and thus the time of call is extraneous or unwanted information). The extraneous information is not processed by sending device 110, while the relevant information is processed by sending device 110.

In step 225, sending device 110 sends a short message service (SMS) or an e-mail to a receiving device in use by the other individual. The SMS can be a text message of the phone, web communication, or the mobile communication systems. For example, a correlation analysis determined that the time of call is not relevant to the information request and thus sending device 110 omits from the SMS or e-mail sent to the receiving device.

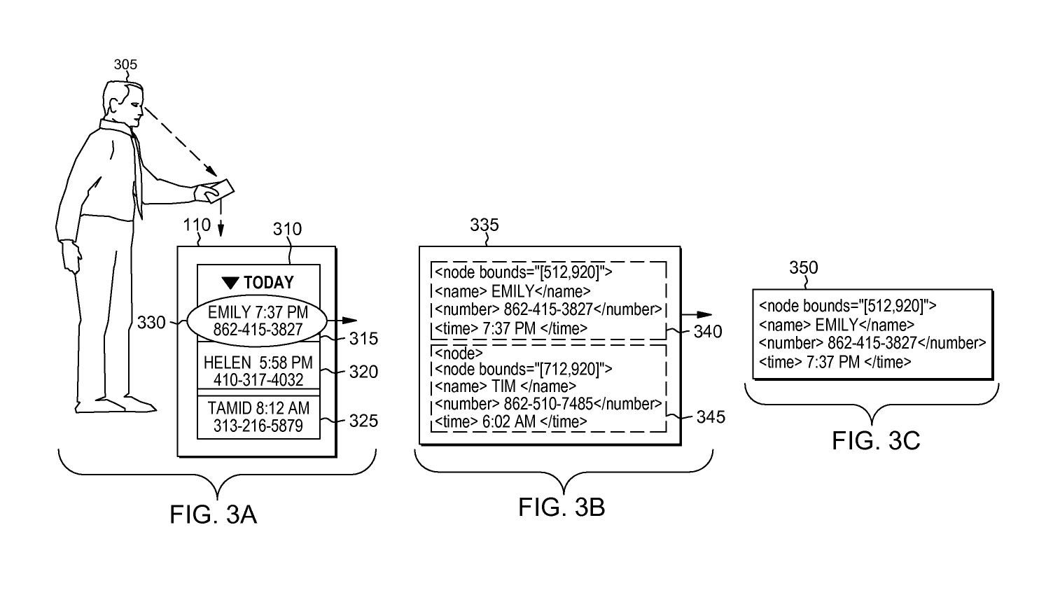

FIG. 3A is an example of a mobile screen display upon initiation of gyroscopic sensors, in accordance with an embodiment of the present invention.

Sending device 110, in use by an individual, changes in position and thus triggers gyroscopic data shifts as described in step 200. In this exemplary embodiment, sending device 110 moves from the ear of user 305 to the front view of user 305. In this embodiment, sending device 110 automatically displays the call history 310 of the current day, in response to a gyroscopic data shift. In other embodiments, other displays may be shown in response to a sensor (gyroscopic or otherwise). Call history 310 depicts three different call entries 315, 320, and 325. A set of information for a caller is contained within each call entry (315, 320, and 325) including the caller's name, phone number, and time of call. Call entries 315, 320, and 325 are data points that can be described in XML node terms which will be described in further detail with respect to FIG. 3B. Sending device 110 in use by an individual has a screen displaying a call history 310. In this exemplary embodiment, sending device 110 receives a hover gesture from the individual using sending device 110 (step 205 of FIG. 2). The area which is encompassed by the hover gesture is depicted by selection 330. The hover gesture is a way of capturing an area on the screen of sending device 110 to form the selection area. Selection 330 has a hierarchy mode view 335 (FIG. 3B) encoded in XML.

FIG. 3B is an example of a user interface displaying a hierarchy mode, in accordance with an embodiment of the present invention.

In this exemplary embodiment, hierarchy mode 335 is initiated (step 210 of FIG. 2) and the entries or other visible elements on a screen of sending device 110 are located within a node. Nodes represent information contained within a single structure where information can be a value, set of data points, or a separate data structure. In this exemplary embodiment, the node within hierarchy mode 335 has a set of node bounds which are the physical boundaries of a selection area with an upper left hand boundary of the encirclement and a lower right hand boundary of the encirclement. Certain information is contained within an encirclement. The encirclement (depicted as selection 330 in FIG. 3A) has a nodal description located within hierarchy mode 335. Data description 340 contains the node bounds, “[512, 920]” where “512” represents the upper left hand boundary of selection area 330 (in FIG. 3A) and “920” represents the lower right hand boundary of selection area 330 (in FIG. 3A). The other information, such as the name of the caller, the phone number of the caller, and the time of the call are also described in XML code. For example, the name of the caller is “Emily” so the name is encoded in XML as “<name>EMILY</name>” as depicted in data description 340. Since the initiated hierarchy module in this case has “categories” in the form of the name of the caller (name), the telephone number of the caller (number), and the time of the call (time) within the node bounds dictated by the encirclement, other nodes will similarly be distinguished in XML code under node bounds, name, number, and time as depicted in hierarchy mode 335. The relevant node to selection area 330 is located within data description 340. The sending device treats other aspects of the screen as nodes in XML format. Since the information in data description 345 is not within selection area 330, it is not relevant (and not incorporated) as captured text which is described in further detail with respect to FIG. 3C.

FIG. 3C is an example of the captured relevant text with respect to the information requested, in accordance with an embodiment of the present invention.

As the only information relevant to selection area 330 (in FIG. 3A) is within data description 340, the information within data description 340 is captured as data 350. The data of information within data 350 is compared to the converted audio-to-text data in order to identify the requested information as described as above.

FIG. 4 is an example of correlating captured text from a hierarchy mode with the text from recording audio, in accordance with an embodiment of the present invention.

In this exemplary embodiment, sending device 110 initiates the hierarchy module and records the audio of a conversation (step 210 of FIG. 2). Data 400 is an example of the data from a hierarchy module and data 405 is the resulting text after the conversion of the recorded audio to text (step 220 of FIG. 2). Data 400 contains a call entry with the name of the caller (“REZINA”), phone number (“862-919-3854”), and time of call (“3:12 PM”). There is a request for the name of the caller and the caller's phone number. While recording the conversation, due to inconsistencies in pronunciation, sending device 110 processes and hears a name. However, the name ‘REZINA’ is not pronounced properly. Instead of the proper pronunciation of “Ray-zee-nuh,” the user of the sending device pronounces the name as “Rye-zee-nuh” and recites REZINA's phone number incorrectly as 862-919-3853 instead of 862-919-3854. Thus in data 405, “RIZENA” is the resulting recorded name and “862-919-3853” is the resulting recorded phone number. A correlation analysis 410 is performed on data 400 and data 405. Correlation step 410 is carried out so the sending device can identify information with a higher accuracy. For example in this instance, the captured text from data 400 has accurate, yet some extraneous, information while data 405 has inaccurate information, yet no extraneous information. String matching algorithms can be used to compare the conversion of recorded audio to text with the data captured from the hierarchy module. The extraneous information of the time of the call does not correlate with the conversion of audio to text so it is omitted. Correlation step 410 is able to disambiguate mispronunciations and recognize analogous data. Even though in data 405 the name is spelled as “RIZENA”, correlation step 410 can recognize the name, from data 400, is supposed to be “REZINA”. Content 410 is sent from the sending device to the receiving device as an email or SMS. The result of correlation step 410 is the extracted information within content 415 (“REZINA 862-919-3854”).

FIG. 5 depicts a block diagram of internal and external components of computing device 500, such as the mobile devices of FIG. 1, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer readable storage media.

Program instructions and data used to practice embodiments of the present invention may be stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of network 125. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to computing device 500. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., software and data, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for sending information during a call, the method comprising:
receiving, by one or more processors, a user gesture during a call;
receiving, by one or more processors, a user selection associated with a requested piece of information;
responsive to receiving the user selection, recording, by one or more processors, a portion of a conversation;
converting, by one or more processors, the recorded portion of the conversation to text; and
sending, by one or more processors, the requested piece of information.

2. The method of claim 1, wherein the user gesture comprises:
a gyroscopic data shift or a user input.

3. The method of claim 1, wherein the user selection comprises:
a hover gesture near a display; or
a touch contact with a display.

4. The method of claim 1, further comprising:
detailing, by one or more processors, the user selection associated with the requested piece of information as a set of XML data.

5. The method of claim 1, wherein recording a portion of a conversation comprises:
initiating, by one or more processors, an audio module responsive to receiving a user gesture; and
stopping, by one or more processors, the audio module responsive to detecting at least one preconfigured user gesture, wherein the at least one preconfigured user gesture comprises at least one of: a touch gesture and a spoken keyword.

6. The method of claim 4, wherein converting the recorded portion of the conversation to text, comprises:
comparing, by one or more processors, the set of XML data to a set of elements associated with a converted recorded portion of the conversation; and
detecting, by one or more processors, a portion of the set of XML data which is substantially similar to the set of elements associated with the converted recorded portion of the conversation.

7. The method of claim 6, further comprising:
deleting, by one or more processors, a first set of information from the set of XML data, responsive to detecting a portion of the set of XML data is not substantially similar to the set of elements associated with the converted recorded portion of the conversation; and
extracting, by one or more processors, a second set of information from the set of XML data, responsive to detecting a portion of the set of XML data is substantially similar to the set of elements associated with the converted recorded portion of the conversation.

8. A computer program product for sending information during a call, the computer program product comprising:
a computer readable storage medium and program instructions stored on the computer readable storage medium, the program instructions comprising:
program instructions to receive a user gesture during a call;
program instructions to receive a user selection associated with a requested piece of information;
responsive to receiving the user selection, program instructions to record a portion of a conversation;
program instructions to convert the recorded portion of the conversation to text; and
program instructions to send the requested piece of information to another device.

9. The computer program product of claim 8, wherein the user gesture comprises:
a gyroscopic data shift or a user input.

10. The computer program product of claim 8, wherein the user selection comprises:
a hover gesture near a display; or
a touch contact with a display.

11. The computer program product of claim 8, further comprising:
program instructions to detail the user selection associated with the requested piece of information as a set of XML data.

12. The computer program product of claim 8, wherein program instructions to record a portion of a conversation comprise:
program instructions to initiate an audio module responsive to receiving a user gesture; and
program instructions to stop the audio module responsive to detecting at least one preconfigured user gesture, wherein the at least one preconfigured user gesture comprises at least one of: a touch gesture and a spoken keyword.

13. The computer program product of claim 11, wherein program instructions to convert the recorded portion of the conversation to text comprise:
program instructions to compare the set of XML data to a set of elements associated with a converted recorded portion of the conversation; and
program instructions to detect a portion of the set of XML data which is substantially similar to the set of elements associated with the converted recorded portion of the conversation.

14. The computer program product of claim 13, further comprising:
program instructions to delete a first set of information from the set of XML data, responsive to detecting a portion of the set of XML data is not substantially similar to the set of elements associated with the converted recorded portion of the conversation; and
program instructions to extract a second set of information from the set of XML data, responsive to detecting a portion of the set of XML data is substantially similar to the set of elements associated with the converted recorded portion of the conversation.

15. A computer system for sending information during a call, the computer system comprising:
one or more computer processors;
one or more computer readable storage media;
program instructions to receive a user gesture during a call;
program instructions to receive a user selection associated with a requested piece of information;
responsive to receiving the user selection, program instructions to record a portion of a conversation;
program instructions to convert the recorded portion of the conversation to text; and
program instructions to send the requested piece of information to another device.

16. The computer system of claim 15, wherein the user selection comprises:
a hover gesture near a display; or
a touch contact with a display.

17. The computer system of claim 15, further comprising:
program instructions to detail the user selection associated with the requested piece of information as a set of XML data.

18. The computer system of claim 15, wherein program instructions to record a portion of a conversation comprise:
program instructions to initiate an audio module responsive to receiving a user gesture; and
program instructions to stop the audio module responsive to detecting at least one preconfigured user gesture, wherein the at least one preconfigured user gesture comprises at least one of: a touch gesture and a spoken keyword.

19. The computer system of claim 17, wherein program instructions to convert the recorded portion of the conversation to text comprise:
program instructions to compare the set of XML data to a set of elements associated with a converted recorded portion of the conversation; and
program instructions to detect a portion of the set of XML data which is substantially similar to the set of elements associated with the converted recorded portion of the conversation.

20. The computer system of claim 19, further comprising:
program instructions to delete a first set of information from the set of XML data, responsive to detecting a portion of the set of XML data is not substantially similar to the set of elements associated with the converted recorded portion of the conversation; and
program instructions to extract a second set of information from the set of XML data, responsive to detecting a portion of the set of XML data is substantially similar to the set of elements associated with the converted recorded portion of the conversation.
